(19) United States
(12) Patent Application Publication
(10) Pub. No.: US 2004/0026186 A1
(43) Pub. Date: Feb. 12, 2004

(54) Wedge-operated disc brake apparatus

(75) Inventor: Takashi Murayama, Kariya-shi (JP)

Correspondence Address: BURNS DOANE SWECKER & MATHIS L L P, POST OFFICE BOX 1404, ALEXANDRIA, VA, 22313-1404, US

(73) Assignee: ADVICS CO., LTD.

(21) Appl. No.: 10/629,653

(22) Filed: Jul. 30, 2003

(30) Foreign Application Priority Data
Aug. 8, 2002 (JP) 2002-231533
May 21, 2003 (JP) 2003-143138

(51) Int. Cl. F16D 55/08

(52) U.S. Cl. 188/72.7

(57) ABSTRACT

A wedge-operated disc brake apparatus includes a piston for pushing a brake pad toward a brake rotor when driven, an actuator for generating a linear brake-actuating input, a wedge transmission mechanism for converting the linear brake-actuating input into a brake-actuating output in the axial direction of the piston, and an automatic gap adjusting mechanism for automatically adjusting a gap between the brake pad and the brake rotor during a non-braking state. The automatic gap adjusting mechanism includes an adjusting wheel having ratchet teeth and provided on an outer circumference of an end portion of the piston, the end portion being toward the wedge transmission mechanism, an adjusting nut provided on an inner circumference of the piston, an adjusting lever having a pawl which is formed on an end of the lever and is engaged with the ratchet teeth of the adjusting wheel, the adjusting lever being rotated via a spring by means of the brake-actuating input so as to rotate the adjusting wheel, and an adjusting bolt threadingly engaged with the adjusting nut and engaged with the brake pad to thereby be prevented from rotating.

### BACKGROUND OF THE INVENTION

1. Field of the Invention

The present invention relates to a wedge-operated disc brake apparatus, and more particularly, to a wedge-operated disc brake apparatus in which a linear brake-actuating input generated upon operation of an actuator is converted, by means of a wedge transmission mechanism, to a brake-actuating output in an axial direction of a piston that is axially, slidably accommodated within a cylinder portion, whereby the piston is driven in the axial direction so as to push brake pads toward a brake rotor.

2. Description of the Related Art

A disc brake apparatus of such a type is disclosed in, for example, Japanese Patent Application Laid-Open (kokai) No. 62-127533. In the disc brake apparatus, a coil spring, which is a component of an automatic gap adjusting mechanism for automatically adjusting a gap between brake pads and a brake rotor during a non-braking state, is disposed in a cylinder portion, coaxially with a piston.

Therefore, when a restriction is imposed on the axial length of the cylinder portion, the axial length (guide length) of the piston, which is slidably accommodated within the cylinder portion, cannot be secured sufficiently, with the result that the piston may incline within the cylinder portion, possibly causing partial wear of the brake pads. When the axial length of the cylinder portion is increased in order to enable the piston to have a sufficiently large axial length (guide length), the dimension of the brake apparatus as measured along the axial direction of the piston increases, and mountability of the brake apparatus on a vehicle may become poor.

### SUMMARY OF THE INVENTION

The present invention was made in order to cope with the above-described problems, and an object of the present invention is to provide a wedge-operated disc brake apparatus which secures a sufficient axial length of a piston accommodated within a cylinder portion even when a restriction is imposed on the axial length of the cylinder portion.

The present invention provides a wedge-operated disc brake apparatus comprising a piston accommodated within a cylinder portion to be rotatable about and slidable along an axial direction of the piston and adapted to push a brake pad toward a brake rotor; an actuator for generating a linear brake-actuating input; a wedge transmission mechanism which is connected to the actuator so as to be driven thereby and to convert the linear brake-actuating input into a brake-actuating output in the axial direction of the piston, the brake-actuating output being transmitted to the piston so as to cause the piston to push the brake pad toward the brake rotor; and an automatic gap adjusting mechanism for automatically adjusting a gap between the brake pad and the brake rotor during a non-braking state.

The automatic gap adjusting mechanism includes an adjusting wheel having ratchet teeth on an outer circumference thereof and provided on an outer circumference of an end portion of the piston, the end portion being toward the wedge transmission mechanism; an adjusting nut provided on an inner circumference of the piston; an adjusting lever having a pawl which is formed on an end of the lever and is engaged with the ratchet teeth of the adjusting wheel, the adjusting lever being rotated via a spring by means of the brake-actuating input so as to rotate the adjusting wheel; and an adjusting bolt threadingly engaged with the adjusting nut and engaged with the brake pad to thereby be prevented from rotating.

In the wedge-operated disc brake apparatus according to the present invention, when the actuator operates in response to braking operation, a linear brake-actuating input generated upon operation of the actuator is converted, by means of the wedge transmission mechanism, into a brake-actuating output in the axial direction of the piston, whereby the piston is axially moved by the brake-actuating output. As a result, the piston pushes the pad toward the brake rotor to thereby brake the brake rotor.

The automatic gap adjusting mechanism of the wedge-operated disc brake apparatus operates during braking operation. Specifically, during braking operation, the adjusting lever is rotated via the spring by a portion of the brake-actuating input. As a result, the adjustment lever rotates the adjusting wheel, whereby the piston rotates together with the adjusting wheel. With the rotation of the piston, the adjusting bolt threadingly engaged with the adjusting nut projects toward the brake rotor, whereby the gap between the brake pad and the brake rotor during a non-braking state is automatically adjusted.

Incidentally, in the wedge-operated disc brake apparatus, the automatic gap adjusting mechanism is composed of an adjusting wheel having ratchet teeth on an outer circumference thereof and provided on an outer circumference of an end portion of the piston, the end portion being toward the wedge transmission mechanism; an adjusting nut provided on an inner circumference of the piston; an adjusting lever having a pawl which is formed on an end of the adjusting lever and is engaged with the ratchet teeth of the adjusting wheel, the adjusting lever being rotated via a spring by means of the brake-actuating input so as to rotate the adjusting wheel; and an adjusting bolt threadingly engaged with the adjusting nut and engaged with the brake pad to thereby be prevented from rotating.

This structure enables the piston to be slidably accommodated within the cylinder portion, except for an end portion thereof located toward the wedge transmission mechanism. Therefore, a sufficient axial length of the piston accommodated within the cylinder portion can be secured even when a restriction is imposed on the axial length of the cylinder portion. Therefore, the wedge-operated disc brake apparatus of the present invention can improve mountability and can suppress partial wear of the pad stemming from inclination of the piston.

In the wedge-operated disc brake apparatus of the present invention, the spring is preferably a tension coil spring disposed in such a manner that a direction of tension of the spring becomes approximately parallel to a plane approximately perpendicular to an axis of a support pin which rotatably supports the adjusting lever. In this case, the adjusting lever properly rotates about the support pin, with little inclination, by means of the load (acting force) of the spring. Therefore, the load of the spring is properly transmitted from the pawl of the adjusting lever to the ratchet teeth of the adjusting wheel, whereby the spring load acts on the adjusting wheel in a stable manner. Accordingly, variation in the function of the automatic gap adjusting mechanism can be suppressed.

### BRIEF DESCRIPTION OF THE DRAWINGS

Various other objects, features and many of the attendant advantages of the present invention will be readily appreciated as the same becomes better understood by reference to the following detailed description of the preferred embodiments when considered in connection with the accompanying drawings, in which:

FIG. 1 is a cross-sectional side elevation of a wedge-operated disc brake apparatus according to a first embodiment of the present invention;

FIG. 2 is a cross-sectional view showing the relation among the gear train, the screw feed mechanism, the wedge transmission mechanism, the automatic gap adjusting mechanism, the brake pads, and the brake rotor shown in FIG. 1;

FIG. 3 is an enlarged cross section of the wedge transmission mechanism shown in FIG. 2;

FIG. 4 is a cross-sectional view taken along line 4-4 of FIG. 3;

FIG. 5 is a cross-sectional side elevation of a wedge-operated disc brake apparatus according to a second embodiment of the present invention;

FIG. 6 is a cross-sectional view showing the relation among the gear train, the screw feed mechanism, the wedge transmission mechanism, the automatic gap adjusting mechanism, the brake pads, and the brake rotor shown in FIG. 5;

FIG. 7 is a partial enlarged view of the wedge transmission mechanism, the automatic gap adjusting mechanism, etc. shown in FIG. 5; and

FIG. 8 is a partial enlarged view of the wedge transmission mechanism, the automatic gap adjusting mechanism, etc. shown in FIG. 6.

### DESCRIPTION OF PREFERRED EMBODIMENTS

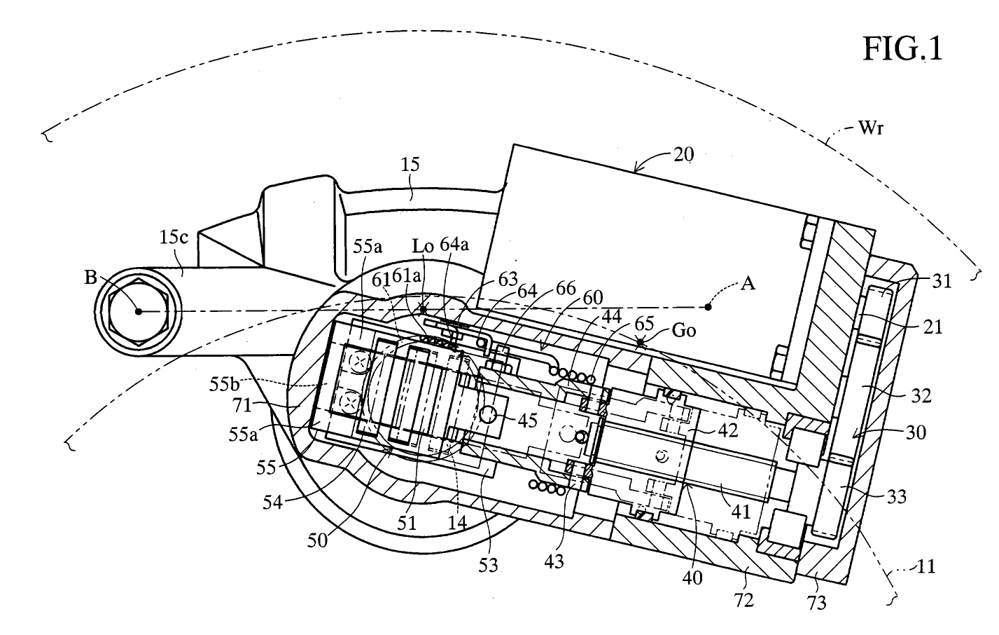

Below, preferred embodiments of the present invention will be described while referring to the accompanying drawings. FIGS. 1 to 4 show a first embodiment of the present invention being employed as a disc brake apparatus for a vehicle. The disc brake apparatus of the present embodiment includes an inner brake pad 12 and an outer brake pad 13 which can grasp between them a brake rotor 11 which is integral with a wheel (in FIG. 1, the location of the inner diameter of the wheel rim is shown by the imaginary line Wr), and a piston 14 and a caliper 15 which can move the brake pads 12 and 13 in the axial direction of the rotor 11 towards the braking surfaces of the brake rotor 11.

The illustrated disc brake apparatus includes an electric motor 20, a gear train 30, a screw feed mechanism 40, and a wedge transmission mechanism 50 for applying a pressing force in the axial direction of the rotor 11 to the piston 14 and the caliper 15. The disc brake apparatus also includes an automatic gap adjusting mechanism 60 for automatically adjusting a gap between the brake pads 12 and 13 and the brake rotor 11 during a non-braking state.

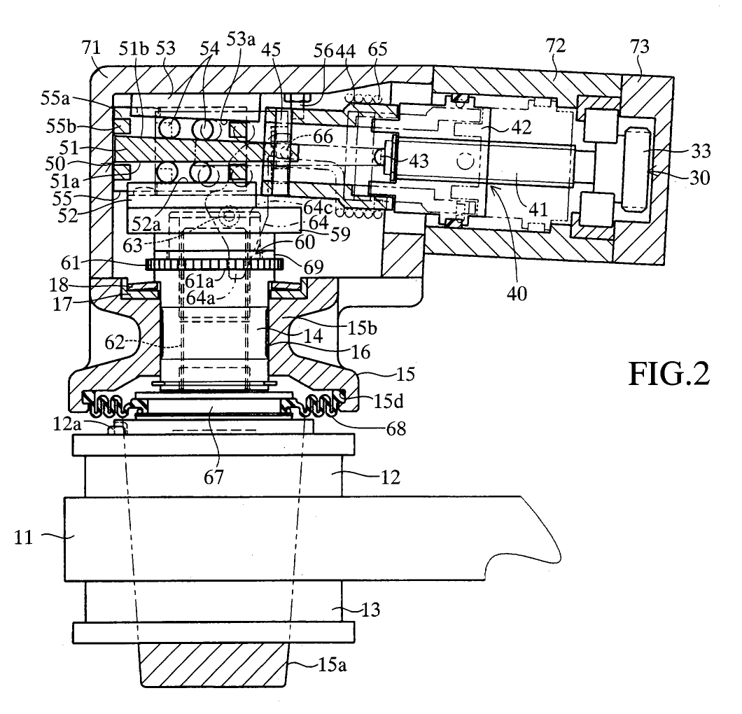

As shown in FIG. 2, the inner brake pad 12 can be moved towards and pressed against the brake rotor 11 by the piston 14. The outer brake pad 13 can be moved towards and pressed against the brake rotor 11 by a reaction arm 15a of the caliper 15. Both brake pads 12 and 13 are mounted on a mounting (a support bracket which is omitted from the drawings and which is mounted on the vehicle body) so as to be able to move in the axial direction of the rotor 11. The braking torque at the time of braking is sustained by the mounting.

The piston 14 is mounted on a cylinder portion 15b of the caliper 15 so as to be rotatable and slidable in the axial direction of the cylinder portion 15b via a cylindrical bearing 16, which is made of a solid lubricant or a similar member and permits smooth axial movement and smooth rotation of the piston 14. The piston 14 is biased in the axial direction of the piston away from the brake rotor 11 by means of a Belleville washer 18 which is disposed together with a support plate 17 between the caliper 15 and the piston 14. An adjusting wheel 61, which is an element of the automatic gap adjusting mechanism 60, is integrally provided on the outer circumference of the piston 14, and an adjusting nut 62, which is another element of the automatic gap adjusting mechanism 60, is integrally provided on the inner circumference of the piston 14.

The caliper 15 includes the above-mentioned reaction arm 15a and cylinder portion 15b, and also includes a pair of connecting arms 15c (one of the arms is shown in FIG. 1). The caliper 15 is attached to the mounting through the connecting arm 15c in a manner well known in the art so as to be able to move in the axial direction of the rotor 11. A first housing 71 which primarily houses the wedge transmission mechanism 50, a second housing 72 which primarily houses the screw feed mechanism 40, and a third housing 73 which primarily houses the gear train 30 are integrally attached to the caliper 15.

The electric motor 20 has a rotating output shaft 21 which is rotationally driven in a forward direction in response to an operation of a brake pedal (not illustrated) and which is rotationally driven in the reverse direction in response to release of the brake pedal. The output shaft 21 is mounted on the second housing 72 in such a manner that the output shaft 21 and a screw shaft 41 of the screw feed mechanism 40 are disposed side by side (the output shaft 21 is disposed in approximately parallel to the screw shaft 41 of the screw feed mechanism 40).

The gear train 30 transmits the rotational drive force of the output shaft 21 of the electric motor 20 as a rotational drive force at a reduced speed to the screw shaft 41, which is an input member of the screw feed mechanism 40. The gear train 30 is disposed between the electric motor 20 and the screw feed mechanism 40. The gear train 30 includes an input gear 31 which is secured to the output shaft 21 of the electric motor 20, an intermediate gear 32 which is rotatably supported by the second housing 72 and which always meshes with the input gear 31, and an output gear 33 which is integrally formed on an end of the screw shaft 41 of the screw feed mechanism 40 and which always meshes with the intermediate gear 32. The input gear 31 has a smaller diameter than the output gear 33 and thus can produce a reduction in speed.

The screw feed mechanism 40 converts the rotational drive force of the electric motor 20 into a drive force in the axial direction of the screw shaft 41 and transmits it to the wedge transmission mechanism 50. The screw feed mechanism 40 includes the screw shaft 41 which is rotatably mounted on the second housing 72, a ball nut 42 which has a female-thread portion in engagement with a male-thread portion of the screw shaft 41 and which is disposed in the second housing 72 so as to be able to move in the axial direction of the screw shaft 41 while being prevented from rotating, a connecting sleeve 44 which is integrally connected to the ball nut 42 through a connecting pin 43, and a connecting pin 45 which connects the connecting sleeve 44 and a wedge member 51 of the wedge transmission mechanism 50.

The wedge transmission mechanism 50 converts the drive force in the axial direction of the screw shaft 41 (linear brake-actuating input) which is transmitted from the screw feed mechanism 40 into a drive force (brake-actuating output) in a direction transverse to the direction of the drive force from the screw feed mechanism 40; i.e., in the axial direction of the piston 14, and transmits it to the piston 14. The wedge transmission mechanism 50 includes an outboard plate 52 which is mounted on an end of the piston 14 via a thrust bearing 69 and a base 59, an inboard plate 53 which opposes the outboard plate 52 and is secured to the first housing 71 by use of screws, and the wedge member 51, which is disposed between the plates 52 and 53 and which engages with rollers 54 disposed between the wedge member 51, and the plates 52 and 53.

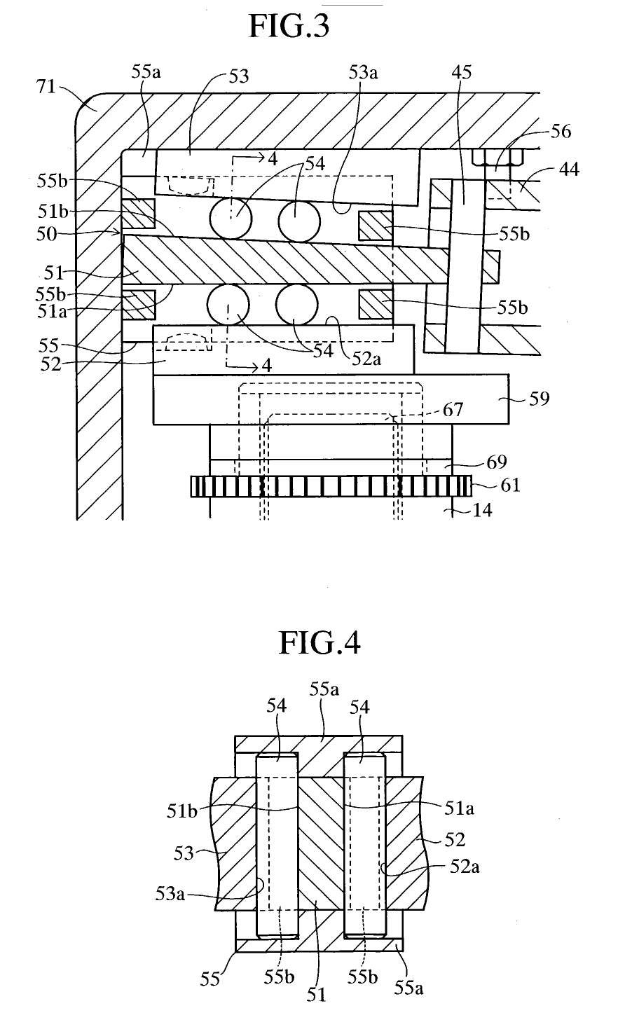

As shown in FIGS. 2 and 3, the wedge member 51 has wedge surfaces 51a and 51b on its outboard and inboard sides, respectively. Two of the rollers 54 are in rolling contact with each of the wedge surfaces 51a and 51b. The wedge surface 51b on the inboard side; i.e., the side facing away from the piston 14 and facing towards the inboard plate 53, is a sloping wedge surface. The outboard plate 52 is secured to the base 59 by use of screws. The outboard plate 52 can move, together with the piston 14, in the axial direction of the piston 14 and can rotate, together with the base 59, about the axis of the piston 14 with respect thereto. The inboard side of the outboard plate 52 (the side facing away from the piston 14) has a flat engaging surface 52a which is parallel to the wedge surface 51a on the outboard side of the wedge member 51. The rollers 54 disposed between the wedge member 51 and the outboard plate 52 are in rolling contact with the opposing parallel surfaces 51a and 52a of the wedge member 51 and the outboard plate 52.

The outboard side (the side facing the piston 14) of the inboard plate 53 has a sloping engaging surface 53a which is parallel to the surface 51b of the inboard side (the side facing away from the piston 14) of the wedge member 51. This sloping engaging surface 53a of the inboard plate 53 is in rolling contact with the rollers 54 disposed between it and the wedge member 51. The sloping engaging surface 53a of the inboard plate 53 is roughly parallel to the axial direction of the screw shaft 41 of the screw feed mechanism 40. The direction of movement of the wedge member 51 roughly coincides with the direction of movement of the ball nut 42 and the connecting sleeve 44 of the screw feed mechanism 40 (the axial direction of the screw shaft 41).

The wedge transmission mechanism 50 includes a holder 55 which rotatably holds the rollers 54 and also holds the wedge member 51 so as to allow straight or linear movement in the axial direction of the screw shaft 41. When the wedge member 51 moves linearly, the holder 55 moves in the axial direction of the screw shaft 41 while being guided by the plates 52 and 53. As shown in FIG. 4, the holder 55 includes a pair of plates 55a which constrain the wedge member 51 and the plates 52 and 53 in a direction roughly perpendicular to the axial direction of the screw shaft 41 (the axial direction of the rollers 54), and four connecting pillars 55b which integrally connect the pair of plates 55a. The amount of movement of the holder 55 in the axial direction of the screw shaft 41 is limited by the first housing 71 and by a stopper bolt 56 secured thereto.

The automatic gap adjusting mechanism 60 includes the above-described adjusting wheel 61 and adjusting nut 62 which are integrally formed on the piston 14. The automatic gap adjusting mechanism 60 also includes an adjusting lever 64 which is rotatably mounted, at its intermediate portion 64c, on the first housing 71 via a support pin 63 and which has a pawl 64a formed on an end thereof (output-side end) and engaged with a ratchet tooth 61a of the adjusting wheel 61. A tension coil spring 65 is disposed so as to engage with the base end (input-side end) of the adjusting lever 64 and engage with the connecting sleeve 44. The spring 65 biases the adjusting lever 64 in the clockwise direction in FIG. 2.

Moreover, the automatic gap adjusting mechanism 60 includes a pressing pin 66 mounted on the connecting sleeve 44, and an adjusting bolt 67 with which the adjusting nut 62 threadingly engages so that the nut 62 can rotate. The pressing pin 66 presses the adjusting lever 64 towards the position shown by solid lines when the connecting sleeve 44 returns to the position shown by solid lines in FIG. 1 and FIG. 2. The adjusting bolt 67 engages with a projection 12a on a backing plate of the inner brake pad 12 so as to be prevented from rotating.

A sealing boot 68 is mounted on the outer periphery of the projecting portion of the adjusting bolt 67. The outer periphery of the boot 68 fits inside and is secured to an annular groove 15d which is formed in the caliper 15. The thrust bearing 69, which is provided between the adjusting wheel 61 and the base 59 supporting the outboard plate 52 of the wedge transmission mechanism 50, enables smooth relative rotation between the base 59 and the adjusting wheel 61. The thrust bearing 69 is rotatably provided on the outer circumference of a cylindrical portion of the piston 14, which portion axially projects by a predetermined amount from an end portion of the piston 14 where the adjusting wheel 61 is provided. The base 59 has an inner hole which is open toward the piston 14, and is attached to the projecting cylindrical portion of the piston 14 in such a manner that the cylindrical portion is rotatably received in the inner hole of the base 59.

In this automatic gap adjusting mechanism 60, when, during braking, the connecting sleeve 44 moves from the position shown by solid lines in FIG. 1 and FIG. 2 to the position shown by imaginary lines, the adjusting lever 64, which is in a retracted position, is rotated in the clockwise direction in FIG. 2 through the coil spring 65 by a portion of the drive force in the axial direction of the screw shaft 41 (brake-actuating input). When the brake pedal is released, the adjusting lever 64 is pressed by the pressing pin 66 and is rotated in the counterclockwise direction in FIG. 2 and returns to its retracted position.

When the adjusting lever 64 is rotated in the clockwise direction in FIG. 2 during brake operation, the pawl 64a of the adjusting lever 64 engages with a ratchet tooth 61a of the adjusting wheel 61 and rotates the adjusting wheel 61. When the adjusting lever 64 is rotated in the counterclockwise direction in FIG. 2 to its retracted position when the brake pedal is released, the pawl 64a of the adjusting lever 64 separates from the ratchet tooth 61a of the adjusting wheel 61, and the adjusting wheel 61 is not rotated.

Therefore, in this automatic gap adjusting mechanism 60, when brake operation takes place, the adjusting wheel 61 is rotated by the adjusting lever 64 and the piston 14 rotates together with the adjusting wheel 61 as a single body. Because of the rotation of the piston 14, the adjusting bolt 67 which is threadingly engaged with the adjusting nut 62 is made to project towards the brake rotor 11, and the gap between the brake pads 12 and 13 and the brake rotor 11 in a non-actuated state is automatically adjusted.

When the amount of return movement of the pawl 64a of the adjusting lever 64 is at least an amount corresponding to the pitch of the ratchet teeth 61a formed on the adjusting wheel 61, the pawl 64a of the adjusting lever 64 engages with the next ratchet tooth 61a when the adjusting lever 64 returns to its retracted position. Therefore, at the time of the next brake operation, the pawl 64a of the adjusting lever 64 engages with the next ratchet tooth 61a and rotates the adjusting wheel 61, so that the above-described gap is adjusted.

In the disc brake apparatus of the first embodiment having the above-described structure, when the output shaft 21 of the electric motor 20 is rotatably driven by operation by the brake pedal (not shown), the rotational drive force of the electric motor 20 is transmitted to the screw shaft 41 of the screw feed mechanism 40 through the gear train 30, and the rotational drive force is converted into a drive force in the axial direction of the screw shaft 41 by the screw feed mechanism 40.

The drive force which is converted into the axial direction of the screw shaft 41 in the screw feed mechanism 40 is transmitted to the wedge member 51 from the ball nut 42 through the connecting pin 43, the connecting sleeve 44, and the connecting pin 45. The drive force is converted into a drive force in the axial direction of the piston 14 by the wedge transmission mechanism 50, and the drive force is transmitted to the piston 14 from the outboard plate 52 through the base 59 and the thrust bearing 69.

Therefore, the piston 14 is driven in its axial direction, it pushes the inner brake pad 12 towards the brake rotor 11, and, by its reaction, the reaction arm 15a of the caliper 15 moves the outer brake pad 13 towards the brake rotor 11, and the brake rotor 11 is grasped between the inner brake pad 12 and the outer brake pad 13. As a result, a braking force is generated between the brake pads 12 and 13, and the brake rotor 11, and the brake rotor 11 is braked.

Incidentally, in the disc brake apparatus of the first embodiment, the automatic gap adjusting mechanism 60 for automatically adjusting the gap between the brake pads 12 and 13 and the brake rotor 11 during a non-braking state is composed of the adjusting wheel 61 provided on the outer circumference of the end portion of the piston 14 located toward the wedge transmission mechanism; the adjusting nut 62 provided on the inner circumference of the piston 14; the adjusting lever 64 which has the pawl 64a engaged with the ratchet teeth 61a of the adjusting wheel 61 and which is rotated via the spring 65 by means of the drive force in the axial direction of the screw (the brake-actuating input); the adjusting bolt 67 threadingly engaged with the adjusting nut 62 and engaged with the brake pad 12 to thereby be prevented from rotating; etc.

This structure enables the piston 14 to be slidably accommodated within the cylinder portion 15b, except for an end portion thereof located toward the wedge transmission mechanism 50. Therefore, a sufficient axial length of the piston 14 accommodated within the cylinder portion 15b can be secured even when a restriction is imposed on the axial length of the cylinder portion 15b. Therefore, the disc brake apparatus can improve mountability and can suppress partial wear of the pad stemming from inclination of the piston 14.

In the disc brake apparatus of the first embodiment, by means of the holder 55 of the wedge transmission mechanism 50, the rollers 54 are rotatably held, and the wedge member 51 is held to be linearly movable; and during linear movement of the wedge member 51, the holder 55 moves along the axial direction of the screw shaft 41 while being guided by the outboard plate 52 and the inboard plate 53.

Therefore, the positional relation among the individual members, such as the plates 52 and 53, the rollers 54, and the wedge member 51, and the direction of movement of the wedge member 51 relative to the plates 52 and 53 can be defined by means of the holder 55. Since the plates 52 and 53 and the rollers 54 are held at respective proper positions relative to the wedge member 51, an intended wedge effect can be attained stably, and brake output efficiency can be made stable.

The disc brake apparatus of the first embodiment is configured in such a manner that the drive force in the axial direction of the screw shaft 41 (linear brake-actuating input), which is generated through cooperative operations of the electric motor 20, the gear train 30, and the screw feed mechanism 40, acts on the wedge member 51 as a pulling force, which results in generation of a force that cancels out a moment force generated by the difference between the direction of the brake-actuating input and the moving direction of the wedge member 51. Therefore, even in the case in which the acting direction of the brake-actuating input and the moving direction of the wedge member 51 do not coincide and are not located on the same line, transmission of load from the connecting sleeve 44 (a load transmission member for transmitting the brake-actuating input to the wedge member 51) to the wedge member 51 is attained stably.

Therefore, as compared with the case where the brake-actuating input acts on the wedge member 51 as a pushing force, loss involved in the transmission of load from the connecting sleeve 44 to the wedge member 51 can be reduced in order to improve load transmission efficiency, whereby brake output efficiency can be improved and made stable. Notably, when the brake-actuating input acts on the wedge member 51 as a pushing force; i.e., when a pushing force is imposed on the wedge member 51 as in the case of the prior art technique, a moment force is generated by the difference between the direction of the brake-actuating input and the moving direction of the wedge member, whereby load transmission loss is generated.

In the disc brake apparatus of the first embodiment, the gear train 30 which transmits the rotational drive force of the electric motor 20 to the screw shaft 41 of the screw feed mechanism 40 as a rotational drive force is disposed between the electric motor 20 and the screw feed mechanism 40. Therefore, by suitably selecting the structure of the gear train 30, the layout of the electric motor 20 with respect to the screw feed mechanism 40 can be optimized. Accordingly, in this disc brake apparatus, the freedom of installation of the electric motor 20 with respect to the screw feed mechanism 40 can be increased. In addition, the axial dimension of the structure comprising the electric motor 20 and the screw feed mechanism 40 can be decreased. As a result, the mountability of the disc brake apparatus on a vehicle can be improved.

In the disc brake apparatus of the first embodiment, the output shaft 21 of the electric motor 20 and the screw shaft 41 of the screw feed mechanism 40 are disposed side by side (the output shaft 21 of the electric motor 20 is disposed in approximately parallel to the screw shaft 41 of the screw feed mechanism 40). Therefore, the electric motor 20 can be compactly disposed in the shape of a C with respect to the screw feed mechanism 40, a decrease in size of the disc brake apparatus can be achieved, and the mountability of the apparatus can be further improved. The output gear 33 of the gear train 30 is integrally formed on the screw shaft 41 of the screw feed mechanism 40, so that the number of parts of the disc brake apparatus can be decreased, a decrease in the size and weight of the disc brake apparatus can be achieved, and costs can also be decreased.

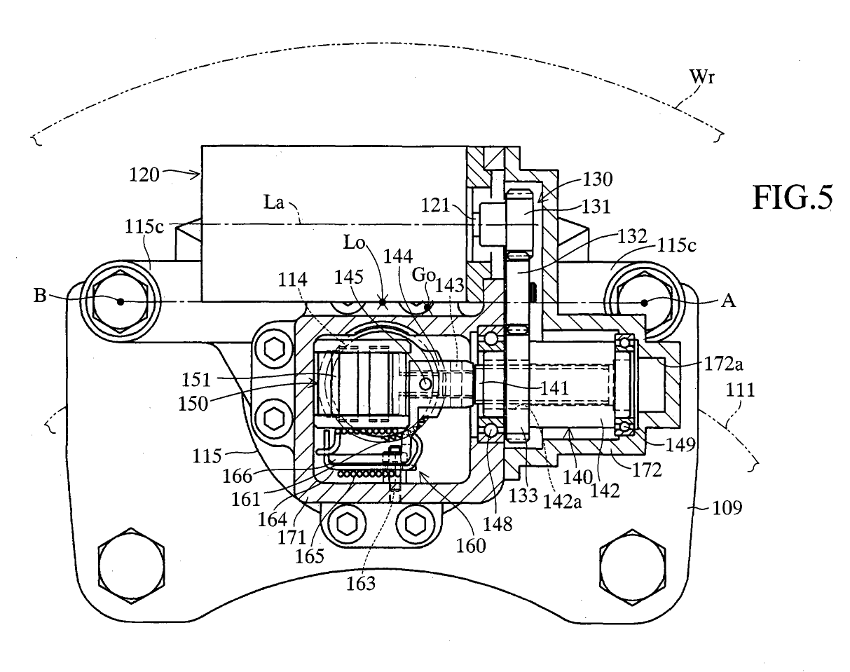

FIGS. 5 to 8 show a second embodiment of the present invention being employed as a disc brake apparatus for a vehicle. The disc brake apparatus of the present embodiment includes an inner brake pad 112 and an outer brake pad 113 which can grasp between them a brake rotor 111 which is integral with a wheel (in FIG. 5, the location of the inner diameter of the wheel rim is shown by the imaginary line Wr), and a piston 114 and a caliper 115 which can move the brake pads 112 and 113 in the axial direction of the rotor 111 towards the braking surfaces of the brake rotor 111.

The illustrated disc brake apparatus includes an electric motor 120, a gear train 130, a screw feed mechanism 140, and a wedge transmission mechanism 150 for applying a pressing force in the axial direction of the rotor 111 to the piston 114 and the caliper 115. The disc brake apparatus also includes an automatic gap adjusting mechanism 160 for automatically adjusting a gap between the brake pads 112 and 113 and the brake rotor 111 during a non-braking state.

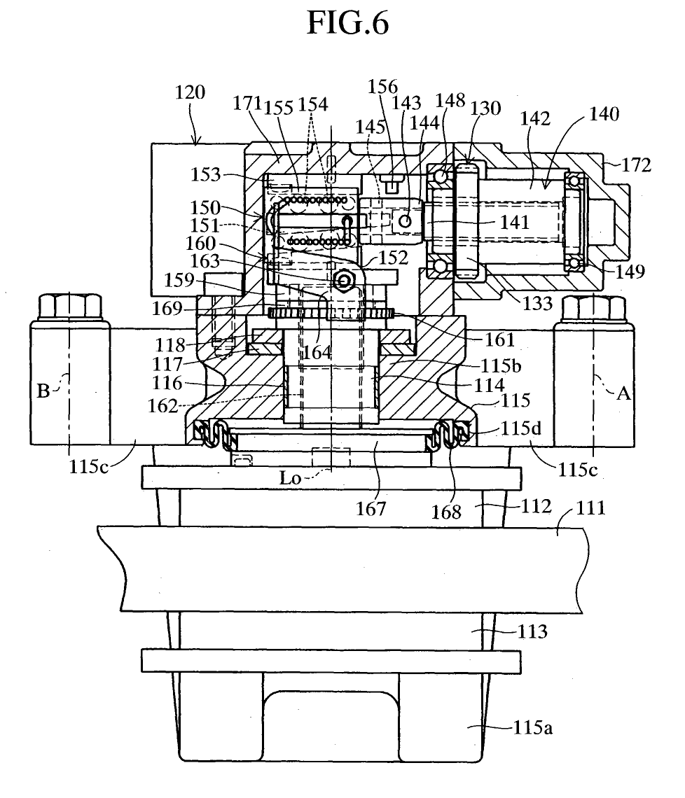

As shown in FIG. 6, the inner brake pad 112 can be moved towards and pressed against the brake rotor 111 by the piston 114. The outer brake pad 113 can be moved towards and pressed against the brake rotor 111 by a reaction arm 115a of the caliper 115. Both brake pads 112 and 113 are mounted on a mounting 109 shown in FIG. 5 (a support bracket mounted on the vehicle body) so as to be able to move in the axial direction of the rotor 111. The braking torque at the time of braking is sustained by the mounting 109.

The piston 114 is mounted on a cylinder portion 115b of the caliper 115 so as to be rotatable and slidable in the axial direction of the cylinder portion 115b via a cylindrical bearing 116, which is made of a solid lubricant or a similar member and permits smooth axial movement and smooth rotation of the piston 114. The piston 114 is biased in the axial direction of the piston away from the brake rotor 111 by means of a Belleville washer 118 which is disposed together with a support plate 117 between the caliper 115 and the piston 114. An adjusting wheel 161, which is an element of the automatic gap adjusting mechanism 160, is integrally provided on the outer circumference of the piston 114, and an adjusting nut 162, which is another element of the automatic gap adjusting mechanism 160, is integrally provided on the inner circumference of the piston 114.

The caliper 115 includes the above-mentioned reaction arm 115a and cylinder portion 115b, and also includes a pair of connecting arms 115c. The caliper 115 is attached to the mounting 109 through the connecting arms 115c and connecting rods (not illustrated) in a manner well known in the art so as to be able to move in the axial direction of the rotor 111. A first housing 171 which primarily houses the wedge transmission mechanism 150, and a second housing 172 which primarily houses the gear train 130 and the screw feed mechanism 140 are integrally attached to the caliper 115.

As shown in FIG. 5, the electric motor 120 has a rotating output shaft 121 which is rotationally driven in a forward direction in response to an operation of a brake pedal (not illustrated) and which is rotationally driven in the reverse direction in response to release of the brake pedal. The output shaft 121 is mounted on the first housing 171 in such a manner that the output shaft 121 and a screw shaft 141 of the screw feed mechanism 140 are disposed side by side (the output shaft 121 is disposed in approximately parallel to the screw shaft 141 of the screw feed mechanism 140).

The gear train 130 transmits the rotational drive force of the output shaft 121 of the electric motor 120 as a rotational drive force at a reduced speed to the ball nut 142, which is an input member of the screw feed mechanism 140. The gear train 130 is disposed between the electric motor 120 and the screw feed mechanism 140. The gear train 130 includes an input gear 131 which is secured to the output shaft 121 of the electric motor 120, an intermediate gear 132 which is rotatably supported by the first housing 171 and which always meshes with the input gear 131, and an output gear 133 which is integrally formed on the outer circumference of an end of the ball nut 142 of the screw feed mechanism 140 and which always meshes with the intermediate gear 132. The input gear 131 has a smaller diameter than the output gear 133 and thus can produce a reduction in speed.

The screw feed mechanism 140 converts the rotational drive force of the electric motor 120 into a drive force in the axial direction of the screw shaft 141 and transmits it to the wedge transmission mechanism 150. The screw feed mechanism 140 includes the ball nut 142, which is supported by the first housing 171 and the second housing 172 via respective bearings 148 and 149 so as to be rotatable, while being prevented from moving in the axial direction of the screw shaft 141, the screw shaft 141 which has a male-thread portion in engagement with a female-thread portion of the ball nut 142 and which can move in the axial direction of the screw shaft 141 while being prevented from rotating, a connecting sleeve 144 which is integrally connected to the screw shaft 141 through a connecting pin 143, and a connecting pin 145 which connects the connecting sleeve 144 and a wedge member 151 of the wedge transmission mechanism 150.

In the screw feed mechanism 140, a hole 142a is formed in an end portion of the ball nut 142 on the side toward the first housing 171. A portion of the connecting sleeve 144 can be accommodated in the hole 142a. Moreover, a concave portion 172a is formed in the second housing 172 and is open toward the screw shaft 141 side. A portion of the screw shaft 141 can be accommodated in the concave portion 172a.

The wedge transmission mechanism 150 converts the drive force in the axial direction of the screw shaft 141 (linear brake-actuating input) which is transmitted from the screw feed mechanism 140 into a drive force (brake-actuating output) in a direction transverse to the drive force from the screw feed mechanism 140; i.e., in the axial direction of the piston 114, and transmits it to the piston 114. The wedge transmission mechanism 150 includes an outboard plate 152 which is mounted on an end of the piston 114 via a thrust bearing 169 and a base 159, an inboard plate 153 which opposes the outboard plate 152 and is secured to the first housing 171 by use of screws, and the wedge member 151, which is disposed between both plates 152 and 153 and which engages with rollers 154 disposed between the wedge member 151, and the plates 152 and 153.

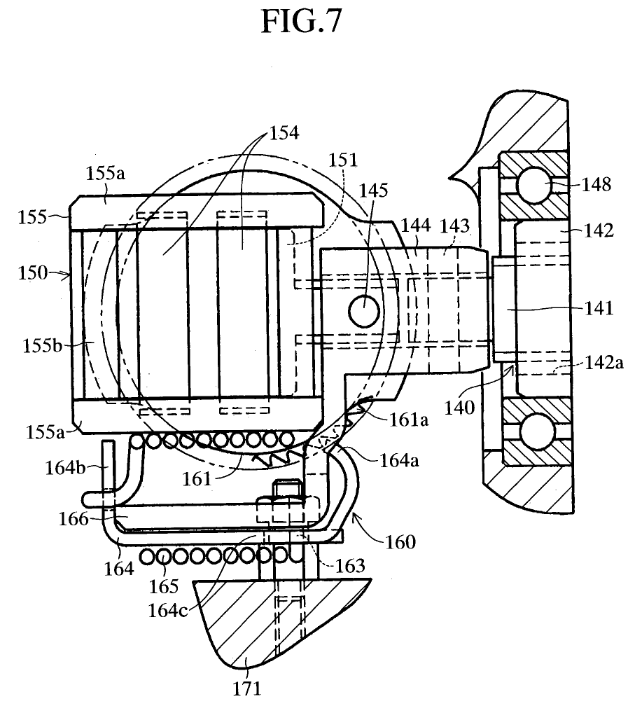

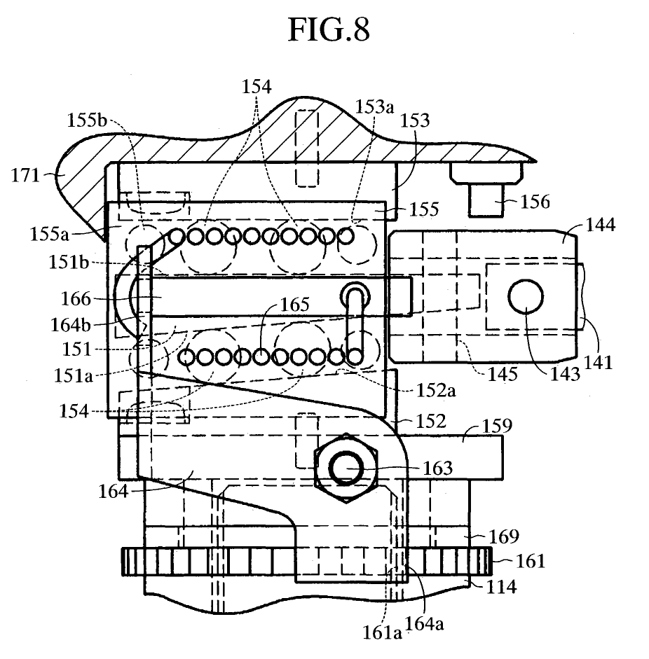

As shown in FIGS. 7 and 8, the wedge member 151 has wedge surfaces 151a and 151b on its outboard and inboard sides, respectively. Two of the rollers 154 are in rolling contact with each of the wedge surfaces 151a and 151b. The wedge surface 151a on the outboard side; i.e., the side facing toward the piston 114 is a sloping wedge surface. The outboard plate 152 is secured to the base 159 by use of screws. The outboard plate 152 can move, together with the piston 114, in the axial direction of the piston 114 and can rotate, together with the base 159, about the axis of the piston 114 with respect thereto. The inboard side of the outboard plate 152 (the side facing away from the piston 114) has a sloping engaging surface 152a which is parallel to the wedge surface 151a on the outboard side of the wedge member 151. The rollers 154 disposed between the wedge member 151 and the outboard plate 152 are in rolling contact with the opposing parallel surfaces 151a and 152a of the wedge member 151 and the outboard plate 152.

The outboard side (the side facing the piston 114) of the inboard plate 153 has a flat engaging surface 153a which is parallel to the surface 151b of the inboard side (the side facing away from the piston 114) of the wedge member 151. This engaging surface 153a of the inboard plate 153 is in rolling contact with the rollers 154 disposed between it and the wedge member 151. This engaging surface 153a of the inboard plate 153 is roughly parallel to the axial direction of the screw shaft 141 of the screw feed mechanism 140. The direction of movement of the wedge member 151 roughly coincides with the direction of movement of the screw shaft 141 and the connecting sleeve 144 of the screw feed mechanism 140 (the axial direction of the screw shaft 141).

The wedge transmission mechanism 150 includes a holder 155 which rotatably holds the rollers 154 and also holds the wedge member 151 so as to allow straight or linear movement in the axial direction of the screw shaft 141. When the wedge member 151 moves linearly, the holder 155 moves in the axial direction of the screw shaft 141 while being guided by the plates 152 and 153. The holder 155 includes a pair of plates 155a which constrain the wedge member 151 and the plates 152 and 153 in a direction roughly perpendicular to the axial direction of the screw shaft 141 (the axial direction of the rollers 154), and four connecting pillars 155b which integrally connect the pair of plates 155a. The amount of movement of the holder 155 in the axial direction of the screw shaft is limited by the first housing 171 and by a stopper bolt 156 secured thereto.

The automatic gap adjusting mechanism 160 includes the above-described adjusting wheel 161 and adjusting nut 162 which are integrally formed on the piston 114. The automatic gap adjusting mechanism 160 also includes an adjusting lever 164 which is rotatably mounted, at its intermediate portion 164c, on the first housing 171 via a support pin 163 and which has a pawl 164a formed on an end thereof (output-side end) and engaged with a ratchet tooth 161a of the adjusting wheel 161, and a tension coil spring 165 which urges the adjusting lever 164 in the clockwise direction in FIG. 6.

Moreover, the automatic gap adjusting mechanism 160 includes a pressing arm 166 integrally formed at an end portion of the connecting sleeve 144, and an adjusting bolt 167 with which the adjusting nut 162 threadingly engages so that the nut 162 can rotate. When the connecting sleeve 144 returns to the position shown in FIG. 5 and FIG. 6, the pressing arm 166 presses the adjusting lever 164 towards the illustrated position. The adjusting bolt 167 engages with a projection 112a on a backing plate of the inner brake pad 112 so as to be prevented from rotating.

The coil spring 165 is installed to accommodate a distal end portion of the pressing arm 166. One end of the coil spring 165 is engaged with the pressing arm 166, and the other end of the coil spring 165 is engaged with the input-side end portion 164b of the adjusting lever 164. The coil spring 165 is disposed in such a manner that the line or direction of the pulling action (i.e., the direction of tension) of the coil spring 165 becomes approximately parallel to a plane approximately perpendicular to the axis of the support pin 163, which rotatably supports the adjusting lever 164.

A sealing boot 168 is mounted on the outer periphery of the projecting portion of the adjusting bolt 167. The outer periphery of the boot 168 fits inside and is secured to an annular groove 115d which is formed in the caliper 115. The thrust bearing 169, which is provided between the adjusting wheel 161 and the base 159 supporting the outboard plate 152 of the wedge transmission mechanism 150, enables smooth relative rotation between the base 159 and the adjusting wheel 161. The thrust bearing 169 is rotatably provided on the outer circumference of a cylindrical portion of the piston 114, which portion axially projects by a predetermined amount from an end portion of the piston 114 where the adjusting wheel 161 is provided. The base 159 has an inner hole which is open toward the piston 114, and is attached to the projecting cylindrical portion of the piston 114 in such a manner that the cylindrical portion is rotatably received in the inner hole of the base 159.

In this automatic gap adjusting mechanism 160, when the connecting sleeve 144 moves toward the ball nut 142 during braking, the adjusting lever 164 which is in the illustrated retracted position is rotated in the clockwise direction in FIG. 6 through the coil spring 165 by a portion of the drive force in the axial direction of the screw shaft 141 (brake-actuating input). When the brake pedal is released, the adjusting lever 164 is pressed by the pressing arm 166 and is rotated in the counterclockwise direction in FIG. 6 and returns to the illustrated retracted position.

When the adjusting lever 164 is rotated in the clockwise direction in FIG. 6 during brake operation, the pawl 164a of the adjusting lever 164 engages with a ratchet tooth 161a of the adjusting wheel 161 and rotates the adjusting wheel 161. When the adjusting lever 164 is rotated in the counterclockwise direction in FIG. 6 to its retracted position when the brake pedal is released, the pawl 164a of the adjusting lever 164 separates from the ratchet tooth 161a of the adjusting wheel 161, and the adjusting wheel 161 is not rotated.

Therefore, in this automatic gap adjusting mechanism 160, when brake operation takes place, the adjusting wheel 161 is rotated by the adjusting lever 164 and the piston 114 rotates together with the adjusting wheel 161 as a single body. Because of the rotation of the piston 114, the adjusting bolt 167 which is threadingly engaged with the adjusting nut 162 is made to project towards the brake rotor 111, and the gap between the brake pads 112 and 113 and the brake rotor 111 in a non-actuated state is automatically adjusted.

When the amount of return movement of the pawl 164a of the adjusting lever 164 is at least an amount corresponding to the pitch of the ratchet teeth 161a formed on the adjusting wheel 161, the pawl 164a of the adjusting lever 164 engages with the next ratchet tooth 161a when the adjusting lever 164 returns to its retracted position. Therefore, at the time of the next brake operation, the pawl 164a of the adjusting lever 164 engages with the next ratchet tooth 161a and rotates the adjusting wheel 161, so that the above-described gap is adjusted.

In the disc brake apparatus of the second embodiment having the above-described structure, when the output shaft 121 of the electric motor 120 is rotatably driven by operation by the brake pedal (not shown), the rotational drive force of the electric motor 120 is transmitted to the ball nut 142 of the screw feed mechanism 140 through the gear train 130, and the rotational drive force is converted into a drive force in the axial direction of the screw shaft 141 by the screw feed mechanism 140.

The drive force which is converted into the axial direction of the screw shaft 141 in the screw feed mechanism 140 is transmitted to the wedge member 151 from the screw shaft 141 through the connecting pin 143, the connecting sleeve 144, and the connecting pin 145. The drive force is converted into a drive force in the axial direction of the piston 114 by the wedge transmission mechanism 150, and the drive force is transmitted to the piston 114 from the outboard plate 152 through the base 159 and the thrust bearing 169.

Therefore, the piston 114 is driven in its axial direction, it pushes the inner brake pad 112 towards the brake rotor 111, and, by its reaction, the reaction arm 115a of the caliper 115 moves the outer brake pad 113 towards the brake rotor 111, and the brake rotor 111 is grasped between the inner brake pad 112 and the outer brake pad 113. As a result, a braking force is generated between the brake pads 112 and 113, and the brake rotor 111, and the brake rotor 111 is braked.

Incidentally, in the disc brake apparatus of the second embodiment having the above-described configuration, the screw feed mechanism 140 whose screw shaft 141 moves axially upon rotation of the ball nut 142 is employed; the output gear 133 of the gear train 130 is integrally formed on the outer circumference of the end portion of the ball nut 142 located on the side toward the wedge transmission mechanism 150; and the electric motor 120 and the wedge transmission mechanism 150 are disposed side by side (the electric motor 120 is disposed in approximately parallel to the wedge transmission mechanism 150).

Therefore, in the disc brake apparatus of the second embodiment, as compared to the first embodiment, the dimension of the apparatus as measured along the axis of the screw shaft 141 can be reduced in order to render the apparatus compact. Further, in the disc brake apparatus of the second embodiment, as shown in FIG. 5, the center of gravity Go of an assembly consisting of the caliper 115 and an actuator consisting of the electric motor 120, the gear train 130, the screw feed mechanism 140, etc. can be made closer to the center axis Lo as compared to the center of gravity Go (the center of gravity of an assembly consisting of the caliper 15 and an actuator consisting of the electric motor 20, the gear train 30, the screw feed mechanism 40, etc.) in the first embodiment shown in FIG. 1. Thus, vibration of the caliper 115 stemming from unsprung vibration can be suppressed. As shown in FIGS. 1, 5, and 6, the center axis Lo is an axis which extends along the axis of the brake rotor (11, 111) while passing through the center of a line extending between the center axes A and B (the center between the center axes A and B) of the connecting rods for connecting the caliper (15, 115) and the mounting (109).

In the disc brake apparatus of the second embodiment, the coil spring 165 is disposed in such a manner that the line or direction of the pulling action (the direction of tension) becomes approximately parallel to a plane approximately perpendicular to the axis of the support pin 163, which rotatably supports the adjusting lever 164. Therefore, the adjusting lever 164 properly rotates about the support pin 163, with little inclination, by means of the load (acting force) of the coil spring 165.

Accordingly, the load of the coil spring 165 is properly transmitted from the pawl 164a of the adjusting lever 164 to the ratchet teeth 161a of the adjusting wheel 161, whereby the load of the coil spring 165 acts on the adjusting wheel 161 in a stable manner. Accordingly, variation in the function of the automatic gap adjusting mechanism 160 can be suppressed.

The disc brake apparatus of the second embodiment has a configuration substantially identical to the configuration of the disc brake apparatus of the first embodiment except that the screw feed mechanism 140 whose screw shaft 141 moves axially upon rotation of the ball nut 142 is employed; the output gear 133 of the gear train 130 is integrally formed on the outer circumference of the end portion of the ball nut 142 located on the side toward the wedge transmission mechanism 150; and the coil spring 165 is disposed in such a manner that the line of the pulling action becomes approximately parallel to a plane approximately perpendicular to the axis of the support pin 163, which rotatably supports the adjusting lever 164. Accordingly, the disc brake apparatus of the second embodiment provides operations and effects similar to those provided by the disc brake apparatus of the first embodiment.

In the disc brake apparatus of the second embodiment, as shown in FIG. 5, the electric motor 120, the gear train 130, the screw feed mechanism 140, the wedge transmission mechanism 150, etc. are disposed in such a manner that the axis La of the electric motor 120 crosses a line connecting the center axis Lo and the axis of the piston 114 at approximately right angles. However, as in the case of the disc brake apparatus of the first embodiment shown in FIGS. 1 to 4, the electric motor 120, the gear train 130, the screw feed mechanism 140, the wedge transmission mechanism 150, etc. may be disposed while being inclined clockwise or counterclockwise about the axis of the piston 114 in FIG. 5. When the electric motor 120, the gear train 130, the screw feed mechanism 140, the wedge transmission mechanism 150, etc. are disposed while being inclined counterclockwise about the axis of the piston 114 in FIG. 5, the above-described center of gravity Go of the assembly including the actuator and the caliper 115 can be made close to the center axis Lo to a possible extent.

In the above-describe embodiments, the linear brake-actuating input which acts on the wedge member 51 or 151 as a pulling force is generated by an actuator consisting of the electric motor 20 or 120, the gear train 30 or 130, the screw feed mechanism 40 or 140, etc. However, the present invention can be practiced while using, instead of the above-described actuator, an actuator which can directly generate a linear brake-actuating input which acts on the wedge member 51 or 151 as a pulling force (e.g., an air motor disclosed in U.S. Pat. No. 4,235,312).

Moreover, in the above-described embodiments, the present invention was applied to a movable caliper-type disc brake apparatus, but the present invention can of course be applied to other types of disc brake apparatuses.

What is claimed is:

1. A wedge-operated disc brake apparatus comprising:
a piston accommodated within a cylinder portion to be rotatable about and slidable along an axial direction of the piston and adapted to push a brake pad toward a brake rotor;
an actuator for generating a linear brake-actuating input;
a wedge transmission mechanism which is connected to the actuator so as to be driven thereby and to convert the linear brake-actuating input into a brake-actuating output in the axial direction of the piston, the brake-actuating output being transmitted to the piston so as to cause the piston to push the brake pad toward the brake rotor; and
an automatic gap adjusting mechanism for automatically adjusting a gap between the brake pad and the brake rotor during a non-braking state,
wherein the automatic gap adjusting mechanism includes
an adjusting wheel having ratchet teeth on an outer circumference thereof and provided on an outer circumference of an end portion of the piston, the end portion being toward the wedge transmission mechanism,
an adjusting nut provided on an inner circumference of the piston,
an adjusting lever having a pawl which is formed on an end of the lever and is engaged with the ratchet teeth of the adjusting wheel, the adjusting lever being rotated via a spring by means of the brake-actuating input so as to rotate the adjusting wheel, and
an adjusting bolt threadingly engaged with the adjusting nut, the adjusting bolt being engaged with the brake pad to thereby be prevented from rotating.

2. A wedge-operated disc brake apparatus according to claim 1, wherein the spring is a tension coil spring disposed in such a manner that a direction of tension of the spring becomes approximately parallel to a plane approximately perpendicular to an axis of a support pin which rotatably supports the adjusting lever.
